(19) United States
(12) Patent Application Publication
(10) Pub. No.: US 2007/0072120 A1
(43) Pub. Date: Mar. 29, 2007

(54) Method for producing resin for chemically amplified positive resist

(75) Inventors: Shinya Okazaki, Himeji-shi (JP); Masafumi Okamoto, Himeji-shi (JP); Yusuke Fuji, Osaka (JP); Hiroaki Fujishima, Niihama-shi (JP)

Correspondence Address: BIRCH STEWART KOLASCH & BIRCH, PO BOX 747, FALLS CHURCH, VA, 22040-0747, US

(73) Assignee: Sumitomo Seika Chemicals Co., Ltd., Hyogo (JP)

(21) Appl. No.: 11/528,443

(22) Filed: Sep. 28, 2006

(30) Foreign Application Priority Data
Sep. 29, 2005 (JP) P2005-283889

(51) Int. Cl. G03C 1/00

(52) U.S. Cl. 430/270.1

(57) ABSTRACT

A method for producing a resin for a chemically amplified positive resist by polymerizing at least one monomer and/or at least one oligomer which is polymerized to provide a resin for a chemically amplified positive resist, in which two or more polymerization initiators are used to initiate the polymerization, thereby the resin is obtained at a high yield.

### FIELD OF THE INVENTION

The present invention relates to a method for producing a resin for a chemically amplified positive resist.

### BACKGROUND OF THE INVENTION

A resin for a chemically amplified positive resist is a resin which has an acid-labile group and which is in itself insoluble or hardly soluble in aqueous alkaline solutions but is made soluble in the aqueous alkaline solutions by the action of an acid thereon. A chemically amplified positive resist comprising such a resin and an acid generator is used in a lithography process in the microfabrication of semiconductors.

A resin for a chemically amplified positive resist may be produced by polymerizing a monomer that provides a resin which has an acid-labile group and which is in itself insoluble or hardly soluble in aqueous alkaline solutions but is made soluble in the aqueous alkaline solutions by the action of an acid thereon, for example, 2-alkyl-2-adamantyl (meth)acrylate and 1-(1-adamantyl)-1-alkylalkyl (meth)acrylate (see, for example, U.S. Pat. No. 6,239,231). However, the yield of such a resin is as low as about 50% in the conventional method. Thus, a new method which produces such a resin at a higher yield has been sought.

### SUMMARY OF THE INVENTION

An object of the present invention is to provide a method for producing a resin for a chemically amplified positive resist at a high yield.

To achieve the above object, the present invention provides the followings:

<1> A method for producing a resin for a chemically amplified positive resist comprising the step of polymerizing at least one monomer and/or at least one oligomer which is polymerized to provide a resin for a chemically amplified positive resist, wherein at least two polymerization initiators are used to initiate the polymerization.

<2> The method according to <1>, wherein each of the polymerization initiators is a compound of the formula (1) or (2): 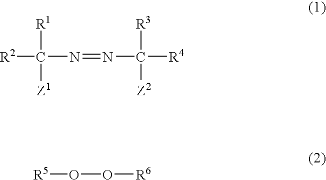
wherein Z¹ and Z² each independently represent an electron-withdrawing group, and R¹, R², R³ R⁴, R⁵ and R⁶ each independently represents an alkyl group having 1 to 10 carbon atoms or an alkyl group containing a cyclic structure and having 3 to 10 carbon atoms, provided that R¹ and R², or R³ and R⁴ may be bonded to form a divalent saturated hydrocarbon group, and that at least one hydrogen atom in the substituents R¹, R², R³, R⁴, R⁵ and R⁶ may optionally be substituted with an aromatic group, a hydroxyl group, a halogen atom or an amino group, or at least one —CH₂— group may optionally be substituted with a carbonyl group or a carboxyl group.

<3>The method according to <1> or <2>, wherein said monomer or oligomer comprises at least one ester, in which a residue of a tertiary alcohol is substituted on a carboxylic acid having an ethylenic double bond and which has a group that is cleaved by the action of an acid.

<4> The method according to <3>, wherein said ester is at least one compound selected from the group consisting of 2-alkyl-2-adamantyl (meth)acrylates, 1-(1-adamantyl)-1-alkylalkyl (meth)acrylates and 1-(2-alkyl-2-adamantyloxycarbonyl)alkyl (meth)acrylates.

<5> The method according to <2>, <3> or <4>, wherein at least one of the polymerization initiators is a compound of the formula (1) recited in <2>.

<6> The method according to <2>, <3> or <4>, wherein all of the polymerization initiators are compounds of the formula (1) recited in <2>.

<7> A resin for a chemically amplified positive resist produced by the method according to any one of <1> to <6>.

<8> A chemically amplified positive resist resin composition comprising a resin for a chemically amplified positive resist produced by the method according to any one of <1> to <6>, an acid generator, and a basic compound.

### DESCRIPTION OF THE PREFERRED EMBODIMENTS

The method of the present invention is characterized in that at least two polymerization initiators are used in combination to initiate the polymerization in the method for producing a resin for a chemically amplified positive resist by polymerizing at least one monomer and/or at least one oligomer which is polymerized to provide a resin for a chemically amplified positive resist.

The polymerization initiators used in the method of the present invention may be conventionally used ones and are not specifically limited. Preferably, each of the polymerization initiators is one that effectively generates radicals by heating. In general, such a polymerization initiator has a chemical structure of the formula (1) or (2): 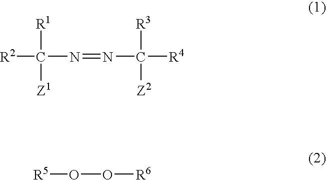
wherein Z¹ and Z² each independently represent an electron-withdrawing group, and R¹, R², R³, R⁴, R⁵ and R⁶ each independently represents a linear or branched alkyl group having 1 to 10 carbon atoms or an alkyl group containing a cyclic structure and having 3 to 10 carbon atoms, provided that R¹ and R², or R³ and R⁴ may be bonded to form a divalent saturated hydrocarbon group, and that at least one hydrogen atom in the substituents R¹, R², R³, R⁴, R⁵ and R⁶ may optionally be substituted with an aromatic group, a hydroxyl group, a halogen atom or an amino group, or at least one —CH₂— group may optionally be substituted with a carbonyl group or a carboxyl group.

Preferable examples of the electron-withdrawing group of Z¹ and Z² include a cyano group, an ester —COOR′ in which R′ is, for example, an alkyl group having 1 to 4 carbon atoms, and the like, although other conventionally known electron-withdrawing groups may be used.

Specific examples of the alkyl group having 1 to 10 atoms of R¹, R², R³, R⁴, R⁵ and R⁶ include a methyl group, an ethyl group, a n-propyl group, an isopropyl group, a n-butyl group, an isobutyl group, a sec-butyl group, a tert-butyl group, a n-pentyl group, an isopentyl group, a sec-pentyl group, a tert-pentyl group, a neopentyl group, a n-hexyl group, an isohexyl group, a sec-hexyl group, a tert-hexyl group, a neohexyl group, a n-heptyl group, a n-octyl group, a n-nonyl group, a n-decyl group, etc. Specific examples of the alkyl group containing a cyclic structure and having 3 to 10 carbon atoms include a cycloalkyl group and an alkylcycloalkyl group such as a cyclopropyl group, a cyclobutyl group, a cyclopentyl group, a 2-methylcyclopentyl group, a cyclohexyl group, a 2-methylcyclohexyl group, a 3-methylcyclohexyl group, a 4-methylcyclohexyl group, a 2,2-dimethylcyclohexyl group, a 4,4-dimethylcyclohexyl group, a cycloheptyl group, a 3-methylcycloheptyl group, a cyclooctyl group, a cyclononyl group, a cyclodecyl group, etc. Specific examples of the divalent hydrocarbon groups formed by the bonding of R¹ and R² or of R³ and R⁴ include a trimethylene group, a tetramethylene group, a pentamethylene group, etc.

Specific examples of the aromatic group as a substituent for at least one hydrogen atom of R¹, R², R³, R⁴, R⁵ and R⁶ include a phenyl group, a naphthyl group, etc. Specific examples of the halogen atom as a substituent include a fluorine atom, a chlorine atom, a bromine atom and an iodine atom.

Specific examples of the polymerization initiators include azo compounds such as 2,2′-azobisisobutyronitrile, 2,2′-azobis(2-methylbutyronitrile), 1,1′-azobis(cyclohexane-1-carbonitrile), 2,2′-azobis(2,4-dimethylvaleronitrile), 2,2′-azobis(2,4-dimethyl-4-methoxyvaleronitrile), dimethyl-2,2′-azobis(2-methylpropionate), 2,2′-azobis(2-hydroxymethylpropionitrile), etc.; organic peroxides such as lauryl peroxide, tert-butyl hydroperoxide, benzoyl peroxide, tert-butyl peroxybenzoate, cumene hydroperoxide, diisopropyl peroxydicarbonate, di-n-propyl peroxydicarbonate, tert-butyl peroxyneodecanoate, tert-butyl peroxypivalate, (3,5,5-trimethylhexanoyl)peroxide, etc.; inorganic peroxides such as potassium persulfate, ammonium persulfate, hydrogen peroxide, etc. At least two of these polymerization initiators are used in combination.

As one of the polymerization initiators, the compound of the above formula (1) is preferably used. More preferably, two or more polymerization initiators are all the compounds of the formula (1). When two polymerization initiators are used, their molar ratio is preferably in the range of 1:1 and 1:10.

As the compound of the formula (1), a compound of the formula (1) in which R¹ to R⁴ are linear or branched alkyl groups having 1 to 6 carbon atoms, and Z¹ and Z² are both cyano groups is preferable. Preferred examples of such a compound include 2,2′-azobis(2,4-dimethylvaleronitrile), 2,2′-azobisisobutyronitrile, 2,2′-azobis(2-methylbutyronitrile), 1,1′-azobis(cyclohexane-1-carbonitrile) and dimethyl-2,2′-azobis(2-methylpropionate). 2,2′-Azobis(2,4-dimethylvaleronitrile) is more preferable. In particular, the combination of 2,2′-azobis(2,4-dimethylvaleronitrile) and 2,2′-azobisisobutyronitrile, the combination of 2,2′-azobis(2,4-dimethylvaleronitrile) and 2,2′-azobis(2-methylbutyrlnitrile), the combination of 2,2′-azobis(2,4-dimethylvaleronitrile) and 1,1′-azobis(cyclohexane-1-carbonitrile), and the combination of 2,2′-azobis(2,4-dimethylvaleronitrile) and dimethyl-2,2′-azobis(2-methylpropionate) are preferable.

In addition, a chain transfer agent such as 1-butanethiol, 2-butanethiol, 1-octanethiol, 1-decanethiol, 1-tetradecanethiol, cyclohexanethiol, 2-methyl-1-propanethiol, etc. may be used in combination with the polymerization initiators.

The polymerization process in the method of the present invention may be radical polymerization, anionic polymerization, coordination polymerization, etc. Among them, the radical polymerization is preferable.

The resin produced by the method of the present invention usually has a weight average molecular weight of 1,000 to 500,000, preferably 4,000 to 50,000.

The monomer and/or oligomer used in the present invention are/is polymerized to provide a resin for a chemically amplified positive resist (hereinafter simply referred to as “Resin”). Resin has an acid-labile group, and it is insoluble or hardly soluble in aqueous alkaline solutions but is made soluble in the aqueous alkaline solutions by the action of an acid thereon.

One example of the acid-labile group is a carboxylate structure: —COOR. Examples of the carboxylate structure include an alkyl ester structure in which a carbon atom of R bonded to the oxygen atom side of the carboxyl group is a quaternary carbon atom, an ester structure in which a residue of a tertiary alcohol is substituted on a carboxylic acid, for example, an alicyclic ester structure such as an isobornyl ester structure, a 1-alkylcycloalkyl ester structure, a 2-alkyl-2-adamantyl ester structure, a 1-(1-adamantyl)-1-alkylalkyl ester structure, etc.

Specific examples of such a carboxylate include (meth)acrylates, norbornenecarboxylates, tricyclodecenecarboxylates, tetracyclodecenecarboxylates, etc.

A monomer or an oligomer preferably used in the present invention is one having an acid-labile group and an olefinic double bond. Such a monomer or an oligomer may be addition polymerized to provide Resin. An ester, in which a residue of a tertiary alcohol is substituted on a carboxylic acid having an ethylenic double bond and which has a group that is cleaved by the action of an acid, is more preferable.

Among those monomers, monomers having, as an acid-labile group, a bulky group such as alicyclic group (e.g. a 2-alkyl-2-adamantyl group and a 1-(1-adamantyl)-1-alkylalkyl group) are preferable, since they can achieve the excellent resolution of a resist obtained.

Examples of such a monomer having a bulky group include 2-alkyl-2-adamantyl(meth)acrylate, 1-(1-adamantyl)-1-alkylalkyl(meth)acrylate, 2-alkyl-2-adamantyl 5-norbornene-2-carboxylate, 1-(1-adamantyl)-1-alkylalkyl 5-norbornene-2-carboxylate, 1-(2-alkykl-2-adamantyloxycarbonyl)alkyl(meth)acrylate, 1-((1-adamantyl)-1-alkylalkyloxycarbonyl)alkykl(meth)acrylate, 2-alkyl-2-adamantyl α-chloroacrylate, 1-(1-adamantyl)-1-alkylalkyl α-chloroacrylate and the like. Examples of the oligomer include those comprising 2 to about 10 molecules of one or more of the above monomers, that is, dimers, trimers, tetramers, pentamers, hexamers, heptamers, octamers, nonamers, decamers, and the like of the above monomers.

Particularly, 2-alkyl-2-adamantyl(meth)acrylate, 1-(1-adamantyl)-1-alkylalkyl(meth)acrylate or 1-(2-alkyl-2-adamantyloxycarbonyl)alkyl(meth)acrylate is preferably used as the monomer for Resin in the present composition, since a resist having excellent resolution can be obtained from the resin of such a monomer.

Typical examples of such a 2-alkyl-2-adamantyl(meth)acrylate include 2-methyl-2-adamantyl acrylate, 2-methyl-2-adamantyl methacrylate, 2-ethyl-2-adamantyl acrylate, 2-ethyl-2-adamantyl methacrylate, 2-isopropyl-2-adamantyl acrylate, 2-isopropyl-2-adamantyl methacrylate, 2-n-butyl-2-adamantyl acrylate, and the like. Typical examples of a 1-(2-alkyl-2-adamantyloxycarbonyl)alkyl(meth)acrylate include 1-(2-methyl-2-adamantyloxycarbonyl)methyl acrylate, 1-(2-methyl-2-adamantyloxycarbonyl)methyl methacrylate, 1-(2-ethyl-2-adamantyloxycarbonyl)methyl acrylate, 1-(2-ethyl-2-adamantyloxycarbonyl)methyl methacrylate, 1-(2-methyl-2-adamantyloxycarbonyl)ethyl acrylate, 1-(2-methyl-2-adamantyloxycarbonyl)ethyl methacrylate, 1-(2-ethyl-2-adamantyloxycarbonyl)ethyl acrylate, 1-(2-ethyl-2-adamantyloxycarbonyl)ethyl methacrylate, 1-(2-methyl-2-adamantyloxycarbonyl)propyl acrylate, 1-(2-methyl-2-adamantyloxycarbonyl)propyl methacrylate, 1-(2-ethyl-2-adamantyloxycarbonyl)propyl acrylate, 1-(2-ethyl-2-adamantyloxycarbonyl)propyl methacrylate, 1-(2-methyl-2-adamantyloxycarbonyl)butyl acrylate, 1-(2-methyl-2-adamantyloxycarbonyl)butyl methacrylate, 1-(2-ethyl-2-adamantyloxycarbonyl)butyl acrylate, 1-(2-ethyl-2-adamantyloxycarbonyl)butyl methacrylate, and the like.

Particularly, 2-ethyl-2-adamantyl(meth)acrylate, 2-isopropyl-2-adamantyl(meth)acrylate or 1-(2-methyl-2-adamantyloxycarbonyl)methyl methacrylate is preferably used, since a resist having excellent resolution and also good heat-resistance can be obtained from the resin of such a monomer.

The 2-alkyl-2-adamantyl(meth)acrylate can usually be prepared by reacting a 2-alkyl-2-adamantanol or a metal salt thereof with an acrylic or methacrylic halide.

The monomer or oligomer used in the present invention may comprise an acid-stable monomer or oligomer besides the above-mentioned monomer or oligomer having an acid-labile group. Herein, an acid-stable monomer or oligomer means a monomer or oligomer having a structure which is not cleaved with an acid generated from an acid generator.

Specific examples of the acid-stable monomer include monomers having a free carboxyl group such as acrylic acid and methacrylic acid, aliphatic unsaturated dicarboxylic anhydrides such as maleic anhydride and itaconic anhydride, 2-norbornene, (meth)acrylonitrile, alkyl(meth)acrylates in which a carbon atom bonded to the oxygen atom side of the carboxyl group is a secondary or tertiary carbon atom, 1-adamantyl(meth)acrylate, styrenic monomers such as p- or m-hydroxystyrene, (meth)acryloyloxy-γ-butyrolactone having a lactone ring optionally substituted by an alkyl group, and the like. Herein, the 1-adamantyl ester group of the 1-adamantyl(meth)acrylate is an acid-stable group, although the carbon atom bonded to the oxygen atom side of the carboxyl group is a quaternary carbon atom. The 1-adamantyl group may have a hydroxyl group. Examples of the oligomer include those comprising 2 to about 10 molecules of one or more of the above monomers.

Specific examples of the acid-stable monomer include a 3-hydroxyl-1-adamantyl(meth)acrylate, 3,5-dihydroxy-1-adamantyl(meth)acrylate, α-(meth)acryloyloxy-γ-butyrolactone, β-(meth)acryloyloxy-γ-butyrolactone, a monomer from which a structural unit of the following formula (a) is derived, a monomer from which a structural unit of the following formula (b) is derived, a monomer from which a structural unit of the following formula (c), hydroxystyrene, an alicyclic compound having an olefinic double bond such as norbornene (d), an aliphatic unsaturated dicarboxylic anhydride such as maleic anhydride (e), itaconic anhydride (f), and the like.

Among them, styrenic monomers such as p- or m-hydroxystyrene, 3-hydroxy-1-adamantyl(meth)acrylate, 3,5-dihydroxy-1-adamantyl(meth)acrylate, a monomer from which a structural unit of the following formula (a) is derived, a monomer from which a structural unit of the following formula (b) is derived, and a monomer from which a structural unit of the following formula (c) is derived are preferable, since they can provide resins for the chemically amplified positive resists having good adhesion to a substrate and excellent resolution. Examples of the oligomer include those comprising 2 to about 10 molecules of one or more of the above monomers. 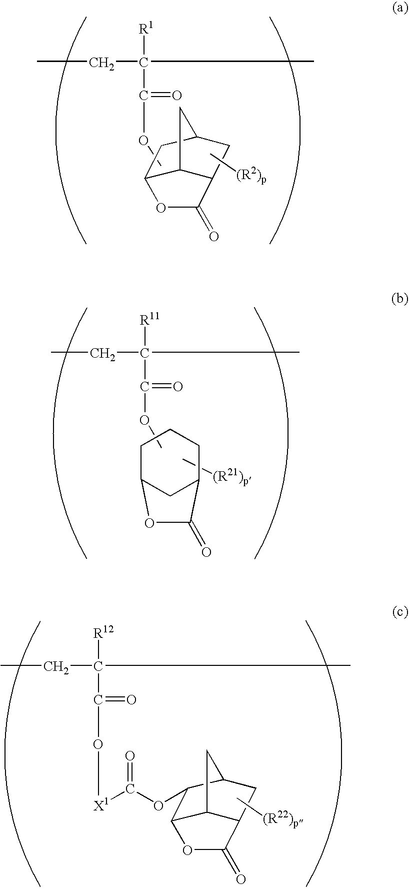
In the formulae (a), (b) and (c), R¹, R¹¹ and R¹² each independently represent a hydrogen atom or a methyl group, R², R²¹ and R²² each independently represent a hydrogen atom, a methyl group, a trifluoromethyl group or a halogen atom, and p, p′ and p″ each independently represent an integer of 1 to 3, provided that when p, p′ or p″ represents 2 or 3, each of R², R²¹ and R²² may be the same or different groups, and X¹ is a divalent hydrocarbon groups having 1 to 12 carbon atoms.

Monomers such as 3-hydroxy-1-adamantyl(meth)acrylate, 3,5-dihydroxy-1-adamantyl(meth)acrylate, and the like may be prepared, for example, by reacting corresponding hydroxyadamantane with (meth)acrylic acid or its acid halide, while they are commercially available.

Furthermore, the monomer such as (meth)acryloyloxy-γ-butyrolactone may be prepared by reacting corresponding α-or β-bromo-γ-butyrolactone having a lactone ring which may be optionally substituted by an alkyl group with acrylic acid or methacrylic acid, or by reacting corresponding α-or β-hydroxy-γ-butyrolactone having a lactone ring which may be optionally substituted by an alkyl group with acrylic halide or methacrylic halide.

Specific examples of the monomers which form the structural units of the formulae (a), (b) and (c) include (meth)acrylates of alicyclic lactones having a hydroxyl group described below, and mixtures thereof. These esters may be prepared by reacting a corresponding alicyclic lactone having a hydroxyl group with (meth)acrylic acid (see, for example, JP-A-2000-26446).

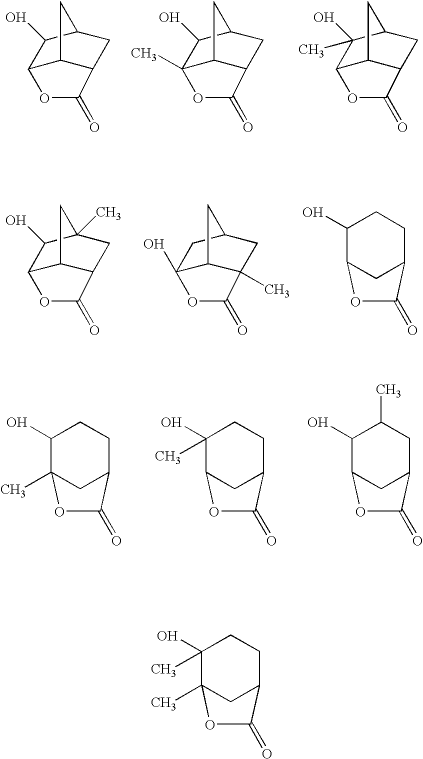

Examples of the (meth)acryloyloxy-γ-butyrolactone include α-acryloyloxy-γ-butyrolactone, α-methacryloyloxy-γ-butyrolactone, α-acryloyloxy-β, β-dimethyl-γ-butyrolactone, α-methacryloyloxy-β, β-dimethyl-γ-butyrolactone, α-acryloyloxy-α-methyl-γ-butyrolactone, αmethacryloyloxy-α-methyl-γ-butyrolactone, β-acryloyloxy-γ-butyrolactone, β-methacryloyloxy-γ-butyrolactone, β-methacryloyloxy-α-methyl-γ-butyrolactone, and the like.

In the case where the chemically amplified positive resist resin composition formulated using the resin for the chemically amplified positive resist is one for KrF excimer laser exposure, a resist resin composition having sufficient transparency can be obtained, even when the styrenic monomer such as p- and m-hydroxystyrene is used. The resin obtained by copolymerizing such monomers may be prepared by radically polymerizing a corresponding (meth)acrylate monomer, acetoxystyrene and styrene, and then deacetylating the copolymer with an acid.

The resin containing a structural unit derived from 2-norbornene has a strong structure since the alicyclic group is directly bonded to its main chain and thus has excellent dry etching resistance. The structural unit derived from 2-norbornene can be introduced into the main chain by radical polymerization using an aliphatic unsaturated dicarboxylic anhydride such as maleic anhydride and itaconic anhydride, in addition to corresponding 2-norbornene. Thus, the structural unit derived from 2-norbornene is formed by the opening of the double bond of the norbornene structure and can be represented by the formula (d), while the structural unit derived from maleic anhydride or itaconic anhydride are formed by the opening of the double bond of maleic anhydride or itaconic anhydride and can be represented by the formula (e) or (f): 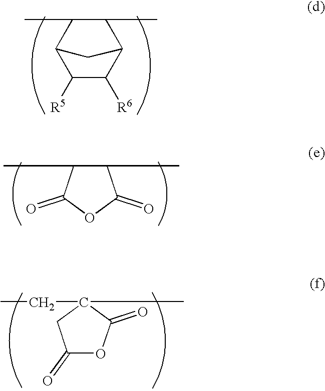
wherein, R⁵ and R⁶ in the formula (d) each independently represent a hydrogen atom, an alkyl group having 1 to 3 carbon atoms, a hydroxyalkyl group having 1 to 3 carbon atoms, a carboxyl group, a cyano group or a group of the formula: —COOU in which U represents an alcohol residue, or R⁵ and R⁶ may together form a carboxylic anhydride residue of the formula: —(═O)OC(═O)—.

When R⁵ and/or R⁶ represent(s) the —COOU group, the carboxyl group is converted to the ester group. In this case, the alcohol residue corresponding to “U” may be an optionally substituted alkyl group having 1 to about 8 carbon atoms, a 2-oxooxolan-3- or 4-yl, etc. Here, the alkyl group may optionally be substituted by a hydroxyl group, an alicyclic hydrocarbon group, etc.

When R⁵ and/or R⁶ represent(s) the alkyl or hydroxyalkyl group, specific examples of the alkyl group include a methyl group, an ethyl group, a propyl group, etc., and specific examples of the hydroxyalkyl group include a hydroxymethyl group, a 2-hydroxyethyl group, etc.

Specific examples of the monomer from which the norbornene structural unit of the formula (d) is derived include 2-norbornene, 2-hydroxy-5-norbornene, 5-norbornene-2-carboxylic acid, methyl 5-norbornene-2-carboxylate, 2-hydroxy-1-ethyl 5-norbornene-2-carboxylate, 5-norbornene-2-methanol, 5-norbornene-2,3-dicarboxylic anhydride, etc.

When U in the —COOU group is an acid-labile group such as the alicyclic ester structure in which the carbon atom bonded to the oxygen atom side of the carboxyl group is a quaternary carbon atom, the structural unit of the formula (d) is still a structural unit having an acid-labile group although it has a norbornene structure. Examples of monomers having a norbornene structure and an acid-labile group include tert-butyl 5-norbornene-2-carboxylate, 1-cyclohexyl-1-methylethyl 5-norbornene-2-carboxylate, 1-methylcyclohexyl 5-norbornene-2-carboxylate, 2-methyl-2-adamantyl 5-norbornene-2-carboxylate, 2-ethyl-2-adamantyl 5-norbornene-2-carboxylate, 1-(4-methylcyclohexyl)-1-methylethyl 5-norbornene-2-carboxylate, 1-(4-hydroxylcyclohexyl)-1-methylethyl 5-norbornene-2-carboxylate, 1-methyl-1-(4-oxocyclohexyl)ethyl 5-norbornene-2-carboxylate, 1-(1-adamantyl)-1-methylethyl 5-norbornene-2-carboxylate, etc.

The content of the structural units derived from the monomer having the acid-labile group in the resin prepared by polymerizing the monomer and/or the oligomer is usually 10 to 80% by mol, although this content may vary with the kind of radiation for patterning exposure, the kind of the acid-labile group, etc.

When the structural units derived from the 2-alkyl-2-adamantyl(meth)acrylate or the 1-(1-adamantyl)-1-alkylalkyl(meth)acrylate are used as the structural units derived from the monomer having an acid-labile group, it is advantageous to include such structural units in an amount of 15% by mol or more of the whole structural units of Resin, since the resin has the strong structure because of the presence of the alicyclic groups, and the resist obtained has good resistance to dry etching.

When other structural units derived from the monomers having an acid-stable group are contained in addition to the structural units derived from the monomers having an acid-labile group, the content of the other structural units is preferably in the range of 20 to 90% by mol based on the whole structural units of Resin.

When an alicyclic compound having an olefinic double bond and an aliphatic unsaturated dicarboxylic anhydride are used as copolymerizable monomers, they are preferably used in an excess amount since they may not be easily polymerized.

Furthermore, monomers having the same olefinic double bond but the different kinds of the acid-labile groups, or monomers having the same acid-labile groups but the different types of the olefinic double bonds, or monomers having the different combinations of the acid-labile group and the olefinic double bond may be used in combination.

In the method of the present invention, an organic solvent used in the polymerization reaction is preferably selected so that the monomer or oligomer, the polymerization initiator and also the copolymer obtained are all dissolved therein. Examples of such organic solvents include hydrocarbons (e.g. toluene, etc.), ethers (e.g. 1,4-dioxane, tetrahydrofurane, etc.), ketones (e.g. methyl isobutyl ketone, etc.), alcohols (e.g. isopropanol, etc.), lactones (e.g. y-butyrolactone, etc.), propylene glycol monomethyl ether acetate, ethyl lactate, and the like. These solvents may be used independently or in admixture of two or more of them.

The reaction temperature in the method of the present invention is usually from 0 to 150° C., preferably from 40 to 100° C.

The method of the present invention can be carried out without any specific limitation. Hereinafter, the method of the present invention will be explained by making reference to radical polymerization, which is a preferable process of polymerization in the present invention. However, the present invention is not limited to this polymerization process.

Firstly, at least one monomer or oligomer is dissolved in an organic solvent, and then at least two polymerization initiators are dissolved in the organic solvent. The resulting reaction mixture is maintained at a specific reaction temperature, whereby the desired resin is formed.

The amount of the solvent is preferably from 1 to 5 times the weight of the monomer or oligomer charged. The amount of the polymerization initiators is preferably from 1 to 20% by mol based on the amount of the monomer or oligomer charged.

When a chemically amplified positive resist resin composition is formulated using the resin for the chemically amplified positive resist produced by the method of the present invention, the resist resin composition contains an acid generator together with the resin.

The acid generator may be at least one compound selected from the group consisting of onium salts, organic halides, sulfone compounds, sulfonate compounds, and so on. Among them, onium salts are preferable. Specific examples of the acid generator include the following compounds: diphenyliodonium trifluoromethanesulfonate, 4-methoxyphenylphenyliodonium hexafluoroantimonate, 4-methoxyphenylphenyliodonium trifluoromethanesulfonate, bis(4-tert-butylphenyl)iodonium tetrafluoroborate, bis(4-tert-butylphenyl)iodonium perfluorobutanesulfonate, bis(4-tert-butylphenyl)iodonium hexafluorophosphate-, bis(4-tert-butylphenyl)iodonium hexafluoroantimonate, bis(4-tert-butylphenyl)iodonium trifluoromethanesulfonate, bis(4-tert-butylphenyl)iodonium camphorsulfonate, triphenylsulfonium hexafluorophosphate, triphenylsulfonium hexafluoroantimonate, triphenylsulfonium trifluoromethanesulfonate, triphenylsulfonium perfluorobutanesulfonate, triphenylsulfonium perfluorooctanesulfonate, tri(4-methylphenyl)sulfonium trifluoromethanesulfonate, tri(4-methylphenyl)sulfonium perfluorobutanesulfonate, tri(4-methylphenyl)sulfonium perfluorooctanesulfonate, 4-methylphenyldiphenylsulfonium perfluorobutanesulfonate, 4-methylphenyldiphenylsulfonium hexafluoroantimonate, 4-methylphenyldiphenylsulfonium trifluoromethanesulfonate, 4-methoxyphenyldiphenylsulfonium hexafluoroantimonate, 4-methoxyphenyldiphenylsulfonium trifluoromethanesulfonate, p-tolyldiphenylsulfonium trifluoromethanesulfonate, p-tolyldiphenylsulfonium perfluorobutanesulfonate, p-tolyldiphenylsulfonium trifluoromethanesulfonate, 2,4,6-trimethylphenyldiphenylsulfonium trifluoromethanesulfonate, 4-tert-butylphenyldiphenylsulfonium trifluoromethanesulfonate, 4-phenylthiophenyldiphenylsulfonium hexafluorophosphate, 4-phenylthiophenyldiphenylsulfonium hexafluoroantimonate, 1-(2-naphthoylmethyl)thiolanium hexafluoroantimonate, 1-(2-naphthoylmethyl)thiolanium trifluoromethanesulfonate, 4-hydroxy-1-naphthyldimethylsulfonium hexafluoroantimonate, 4-hydroxy-1-naphthyldimethylsulfonium trifluoromethanesulfonate, cyclohexylmethyl(2-oxocyclohexyl)sulfonium trifluoromethanesulfonate, cyclohexylmethyl(2-oxocyclohexyl)sulfonium perfluorobutanesulfonate, cyclohexylmethyl(2-oxocyclohexyl)sulfonium perfluorooctanesulfonate, 2-methyl-4,6-bis(trichloromethyl)-1,3,5-triazine, 2,4,6-tris(trichloromethyl)-1,3,5-triazine, 2-phenyl-4,6-bis(trichloromethyl)-1,3,5-triazine, 2-(4-chlorophenyl)-4,6-bis(trichloromethyl)-1,3,5-triazine, 2-(4-methoxyphenyl)-4,6-bis(trichloromethyl)-1,3,5-triazine, 2-(4-methoxy-1-naphthyl)-4,6-bis(trichloromethyl)-1,3,5-triazine, 2-(benzo([d][1,3]dioxolan-5-yl)-4,6-bis(trichloromethyl)-1,3,5-triazine, 2-(4-methoxystyryl)-4,6-bis(trichloromethyl)-1,3,5-triazine, 2-(3,4,5-trimethoxystyryl)-4,6-bis(trichloromethyl)-1,3,5-triazine, 2-(3,4-dimethoxystyryl)-4,6-bis(trichloromethyl)-1,3,5-triazine, 2-(2,4-dimethoxystyryl)-4,6-bis(trichloromethyl)-1,3,5-triazine, 2-(2-methoxystyryl)-4,6-bis(trichloromethyl)-1,3,5-triazine, 2-(4-butoxystyryl)-4,6-bis(trichloromethyl)-1,3,5-triazine, 2-(4-pentyloxystyryl)-4,6-bis(trichloromethyl)-1,3,5-triazine, 1-benzoyl-1-phenylmethyl p-toluenesulfonate (commonly known as benzoine tosylate), 2-benzoyl-2-hydroxy-2-phenylethyl p-toluenesulfonate (commonly known as α-methylolbenzoine tosylate), 1,2,3-benzenetolyl tris(methanesulfonate), 2,6-dinitrobenzyl p-toluenesulfonate, 2-nitrobenzyl p-toluenesulfonate, 4-nitrobenzyl p-toluenesulfonate, diphenyl disulfone, di-p-tolyl disulfone, bis(phenylsulfonyl)diazomethane, bis(4-chlorophenylsulfonyl)diazomethane, bis(p-tolylsulfonyl)diazomethane, bis(4-tert-butylphenylsulfonyl)diazomethane, bis(2,4-xylylsulfonyl)diazomethane, bis(cyclohexylsulfonyl)diazomethane, (benzoyl)(phenylsulfonyl)diazomethane, N-(phenylsulfonyloxy)succinimide, N-(trifluoromethylsulfonyloxy)succinimide, N-(trifluoromethylsulfonyloxy)phthalimide, N-(trifluoromethylsulfonyloxy)-5-norbornene-2,3-dicarboxyimide, N-(trifluoromethylsulfonyloxy)naphthalimide, N-(10-camphorsulfonyloxy)naphthalimide, (5-propylsulfonyloxyimino-5H-thiophen-2-ylidene)-(2-methylphenyl)acetonitrile, (5-(4-methylphenyl)sulfonyloxyimino-5H-thiophen-2-ylidene)-(2-methylphenyl)acetonitrile, (5-butylsulfonyloxyimino-5H-thiophen-2-ylidene)-(2-methylphenyl)acetonitrile, (5-octylsulfonyloxyimino-5H-thiophen-2-ylidene)-(2-methylphenyl)acetonitrile, (5-(2,4,6-trimethylphenyl)sulfonyloxyimino-5H-thiophen-2-ylidene)-(2-methylphenyl)acetonitrile, (5-(2,4,6-triisopropylphenyl)sulfonyloxyimino-5H-thiophen-2-ylidene)-(2-methylphenyl)acetonitrile, (5-(4-dodecylphenyl)sulfonyloxyimino-5H-thiophen-2-ylidene)-(2-methylphenyl)acetonitrile, (5-(2-naphthyl)sulfonyloxyimino-5H-thiophen-2-ylidene)-(2-methylphenyl)acetonitrile, (5-benzylsulfonyloxyimino-5H-thiophen-2-ylidene)-(2-methylphenyl)acetonitrile, (oxydi-4,1-phenylene)bisdiphenylsulfonium bis(methanesulfonate), (oxydi-4,1-phenylene)bisdiphenylsulfonium bis(benzenesulfonate), (oxydi-4,1-phenylene)bisdiphenylsulfonium bis(p-toluenesulfonate), (oxydi-4,1-phenylene)bisdiphenylsulfonium bis(camphorsulfonate), (oxydi-4,1-phenylene)bisdiphenylsulfonium bis(triisopropylbenzenesulfonate), (oxydi-4,1-phenylene)bisdiphenylsulfonium bis(pentafluorobenzenesulfonate), (oxydi-4,1-phenylene)bisdiphenylsulfonium bis(trifluoromethanesulfonate), (oxydi-4,1-phenylene)bisdiphenylsulfonium bis(perfluorobutanesulfonate), (oxydi-4,1-phenylene)bisdiphenylsulfonium bis(perfluorooctanesulfonate), (oxydi-4,1-phenylene)bisdiphenylsulfonium bis(trifluoro-N-[(perfluoromethyl)sulfonyl]sulfonate), (oxydi-4,1-phenylene)bisdiphenylsulfonium bis(perfluoro-N-[(perfluoroethyl)sulfonyl]-1-ethanesulfoneamidate), (oxydi-4,1-phenylene)bisdiphenylsulfonium bis(perfluoro-N-[(perfluorobutyl)sulfonyl]-1-butanesulfoneamidate), (oxydi-4,1-phenylene)bisdiphenylsulfonium bis(trifluoro-N-[(perfluorobutyl)sulfonyl]-1-butanesulfoneamidate), (oxydi-4,1-phenylene)bisdiphenylsulfonium bis(tetrafluoroborate), (oxydi-4,1-phenylene)bisdiphenylsulfonium bis(hexafluoroarsenate), (oxydi-4,1-phenylene)bisdiphenylsulfonium bis(hexafluoroantimonate), (oxydi-4,1-phenylene)bisdiphenylsulfonium bis(hexafluorophosphate), (oxydi-4,1-phenylene)bisdi(4-tert-butylphenyl)sulfonium bis(trifluoromethanesulfonate), (oxydi-4,1-phenylene)bisdi(4-tert-butylphenyl)sulfonium bis(perfluorobutanesulfonate), (oxydi-4,1-phenylene)bisdi(p-tolyl)sulfonium bis(trifluoromethanesulfonate), triphenylsulfonium (adamantan-1-ylmethyl)oxycarbonyldifluoromethanesulfonate, and the like.

The chemically amplified positive resist resin composition, which is formulated using the resin for the chemically amplified positive resist produced by the method of the present invention, may contain a basic compound, particularly, a basic nitrogen-containing organic compound such as an amines, as a quencher, in addition to Resin and the acid generator. The use of the basic compound can suppress the deterioration of the performance caused by the deactivation of the acid which is induced by post exposure delay.

Specific examples of such a basic nitrogen-containing organic compound include the compounds represented by the following formulae:

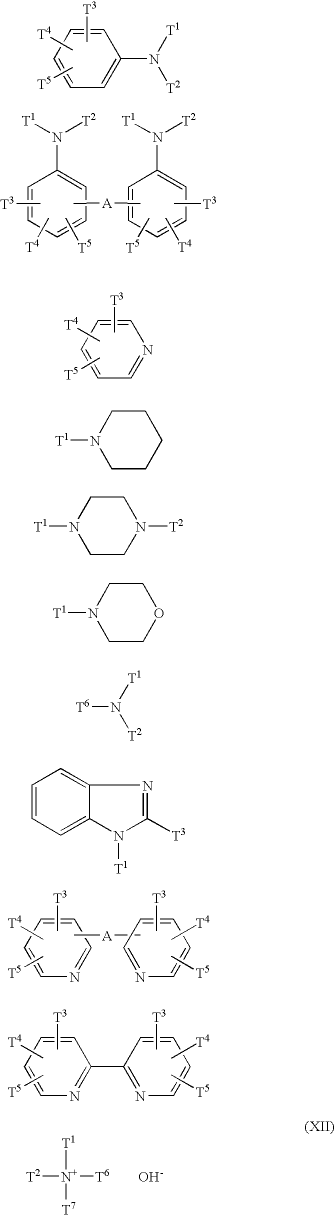

In the above formulas, T¹, T² and T³ each independently represent a hydrogen atom, an alkyl group, a cycloalkyl group or an aryl group. The alkyl group preferably has 1 to about 6 carbon atoms, the cycloalkyl group preferably has about 5 to 10 carbon atoms, and the aryl group preferably has about 6 to 10 carbon atoms. Furthermore, at least one hydrogen atom on the alkyl group, cycloalkyl group or aryl group may be substituted with a hydroxyl group, an amino group, or an alkoxy group having 1 to 6 carbon atoms. At least one hydrogen atom on the amino group may further be substituted with an alkyl group having 1 to 4 carbon atoms. In the formula (XII), none of T¹, T² and T⁷ is a hydrogen atom.

T³, T⁴ and T⁵ each independently represent a hydrogen atom, an alkyl group, a cycloalkyl group, an aryl group or an alkoxy group. The alkyl group preferably has 1 to about 6 carbon atoms, the cycloalkyl group preferably has about 5 to 10 carbon atoms, the aryl group preferably has about 6 to 10 carbon atoms, and the alkoxy group preferably has 1 to about 6 carbon atoms. Furthermore, at least one hydrogen atom on the alkyl group, cycloalkyl group, aryl group or alkoxy group may be substituted with a hydroxyl group, an amino group, or an alkoxy group having 1 to 6 carbon atoms. At least one hydrogen atom on the amino group may further be substituted with an alkyl group having 1 to 4 carbon atoms.

T⁶ represents an alkyl group or a cycloalkyl group. The alkyl group preferably has 1 to about 6 carbon atoms, and the cycloalkyl group preferably has about 5 to 10 carbon atoms. Furthermore, at least one hydrogen atom on the alkyl group or cycloalkyl group may be substituted with a hydroxyl group, an amino group, or an alkoxy group having 1 to 6 carbon atoms. At least one hydrogen atom on the amino group may further be substituted with an alkyl group having 1 to 4 carbon atoms.

“A” represents an alkylene group, a carbonyl group, an imino group, a sulfide group or a disulfide group. The alkylene group preferably has about 2 to 6 carbon atoms.

Moreover, T¹ to T⁷ may have a linear structure or a branched structure, if they can have the both structures.

Examples of such compounds include hexylamine, heptylamine, octylamine, nonylamine, decylamine, aniline, 2-, 3- or 4-methylaniline, 4-nitroaniline, 1- or 2-naphthylamine, ethylenediamine, tetramethylenediamine, hexamethylenediamine, 4,4′-diamino-1,2-diphenylethane, 4,4′-diamino-3,3′-dimethyldiphenylmethane, 4,4′-diamino-3,3′-diethyldiphenylmethane, dibutylamine, dipentylamine, dihexylamine, diheptylamine, dioctylamine, dinonylamine, didecylamine, N-methylaniline, piperidine, diphenylamine, triethylamine, trimethylamine, tripropylamine, tributylamine, tripentylamine, trihexylamine, triheptylamine, trioctylamine, trinonylamine, tridecylamine, methyldibutylamine, methyldipentylamine,. methyldihexylamine, methyldicyclohexylamine, methyldiheptylamine, methyldioctylamine, methyldinonylamine, methyldidecylamine, ethyldibutylamine, ethyldipentylamine, ethyldihexylamine, ethyldiheptylamine, ethyldioctylamine, ethyldinonylamine, ethyldidecylamine, dicyclohexylmethylamine, tris[2-(2-methoxyethoxy)ethyl]amine, triisopropanolamine, N,N-dimethylaniline, 2,6-isopropylaniline, imidazole, pyridine, 4-methylpyridine, 4-methylimidazole, bipyridine, 2,2′-dipyridylamine, di-2-pyridyl. ketone, 1,2-di(2-pyridyl)ethane, 1,2-di(4-pyridyl)ethane, 1,3-di(4-pyridyl)propane, 1,2-bis(2-pyridyl)ethylene, 1,2-bis(4-pyridyl)ethylene, 1,2-bis(4-pyridyloxy)ethane, 4,4′-dipyridyl sulfide, 4,4′-dipyridyl disulfide, 1,2-bis(4-pyridyl)ethylene, 2,2′-dipicolylamine, 3,3′-dipicolylamine, tetramethylammonium hydroxide, tetraisopropylammonium hydroxide, tetrabutylammonium hydroxide, tetra-n-hexylammonium hydroxide, tetra-n-octylammonium hydroxide, phenyltrimethylammonium hydroxide, 3-trifluoromethylphenyltrimethylammonium hydroxide, (2-hydroxyethyl)trimethylammonium hydroxide (so-called “choline”), and the like.

Furthermore, hindered amine compounds having a piperidine skeleton such as disclosed in JP-A-11-52575 can be used as quenchers.

When the compound of the formula (XII) is used as a quencher, the resolution of a resist is preferably improved. Specific examples thereof include tetramethylammonium hydroxide, tetrabutylammonium hydroxides tetrahexylammonium hydroxide, tetraoctylammonium hydroxide, phenyltrimethylammonium hydroxide, 3-trifluoromethyl-phenyltrimethylammonium hydroxide, and the like.

In general, the chemically amplified positive resist resin composition comprising the resin for the chemically amplified positive resist produced according to the present invention contain Resin in an amount of about 80 to 99.9% by weight and the acid generator in an amount of about 0.1 to 20% by weight, based on the total weight of Resin and the acid generator.

When the basic compound is used as a quencher, the basic compound is preferably contained in an amount of about 0.01 to 1% by weight based on the weight of the whole solid content of the resist resin composition.

The chemically amplified positive resist resin composition may contain, if necessary, various additives in small amounts such as sensitizers, dissolving suppressing agents, other resins, surfactants, stabilizers, dyes and the like, as long as the effects of the present invention are not impaired.

The chemically amplified positive resist resin composition is usually formulated in the form of a solution containing the components dissolved in a solvent, and the composition is applied to the surface of a substrate such as a silicon wafer by a conventional coating method such as spin coating and the like. The solvent used here has a sufficient dissolving power for dissolving the components and an adequate drying rate, and leaves a uniform and smooth coating film after the evaporation of the solvent. Herein, solvents conventionally used in this art field may be used.

Examples of the solvent include glycol ether esters such as ethyl cellosolve acetate, methyl cellosolve acetate, propylene glycol monomethyl ether acetate, etc.; esters such as ethyl lactate, butyl acetate, amyl acetate, ethyl pyruvate, etc.; ketones such as acetone, methyl isobutyl ketone, 2-heptanone, cyclohexanone, etc.; cyclic esters such as γ-butyrolactone, etc., and so on. These solvents may be used independently or in admixture of two or more of them.

A resist film applied onto the substrate and then dried is subjected to exposure for patterning, then heat-treated for facilitating a deblocking reaction, and thereafter developed with an alkali developer. The alkali developer used here may be any one of various alkaline aqueous solutions used in the art, and generally, an aqueous solution of tetramethylammonium hydroxide or (2-hydroxyethyl)trimethylammonium hydroxide (commonly known as “choline”) is used.

Hereinafter, the present invention will be illustrated by the following Examples, which do not limit the scope of the present invention in any way.

### EXAMPLE 1

2-Ethyl-2-adamantyl methacrylate (9.70 g), 3-hydroxy-1-adamantyl methacrylate (7.10 g) and tetrahydro-2-oxo-3-furyl methacrylate (5.11 g) (molar ratio=1.3:1:1) were charged in a reactor and then methyl isobutyl ketone was added in an amount of 1.49 times the total weight of the monomers to form a solution. To the solution, azobisisobutyronitrile and azobis(2,4-dimethylvaleronitrile) as polymerization initiators were added in an amount of 1% by mol and 3% by mol, respectively, based on the total amount of the monomers. Then, the reaction mixture was heated at 72° C. for about 6 hours. Thereafter, the reaction mixture was poured in a large amount of a methanol-water mixture to precipitate a produced copolymer. The obtained copolymer was washed with a large amount of methanol, and the washed copolymer was collected by filtration. The washing and filtration were repeated three times. Thereby, the copolymer having a weight average molecular weight Mw of about 8,200 and a molecular weight distribution of 1.61 was obtained at a yield of 72%.

### EXAMPLE 2

2-Ethyl-2-adamantyl methacrylate. (9.70 g), 3-hydroxy-1-adamantyl methacrylate (7.10 g) and tetrahydro-2-oxo-3-furyl methacrylate (5.11 g) (molar ratio=1.3:1:1) were charged in a reactor and then methyl isobutyl ketone was added in an amount of 2.6 times the total weight of the monomers to form a solution. To the solution, azobisisobutyronitrile and azobis(2,4-dimethylvaleronitrile) as polymerization initiators were added in an amount of 1% by mol and 3% by mol, respectively, based on the total amount of the monomers. Then, the reaction mixture was heated at 72° C. for about 6 hours. Thereafter, the reaction mixture was poured in a large amount of a methanol-water mixture to precipitate a produced copolymer. The obtained copolymer was washed with a large amount of methanol, and the washed copolymer was collected by filtration. The washing and filtration were repeated three times. Thereby, the copolymer having a weight average molecular weight Mw of about 7,200 and a molecular weight distribution of 1.52 was obtained at a yield of 65%.

### Comparative Example 1

2-Ethyl-2-adamantyl methacrylate (9.70 g), 3-hydroxy-1-adamantyl methacrylate (7.10 g) and tetrahydro-2-oxo-3-furyl methacrylate (5.11 g) (molar ratio =1.3:1:1) were charged in a reactor and then methyl isobutyl ketone was added in an amount of 2.6 times the total weight of the monomers to form a solution. To the solution, azobisisobutyronitrile as a polymerization initiator was added in an amount of 3% by mol based on the total amount of the monomers. Then, the reaction mixture was heated at 72° C. for about 6 hours. Thereafter, the reaction mixture was poured in a large amount of a methanol-water mixture to precipitate a produced copolymer. The obtained copolymer was washed with a large amount of methanol, and the washed copolymer was collected by filtration. The washing and filtration were repeated three times. Thereby, the copolymer having a weight average molecular weight Mw of about 12,900 and a molecular weight distribution of 1.85 was obtained at a yield of 46%.

### Comparative Example 2

2-Ethyl-2-adamantyl methacrylate (15.0 g), 3-hydroxy-1-adamantyl methacrylate (7.14 g) and tetrahydro-2-oxo-3-furyl methacrylate (5.14 g) (molar ratio =2:1:1) were charged in a reactor and then methyl isobutyl ketone was added in an amount of 2.6 times the total weight of the monomers to form a solution. To the solution, azobisisobutyronitrile as a polymerization initiator was added in an amount of 2% by mol based on the total amount of the monomers. Then, the reaction mixture was heated at 87° C. for about 6 hours. Thereafter, the reaction mixture was poured in a large amount of a methanol-water mixture to precipitate a produced copolymer. The obtained copolymer was washed with a large amount of methanol, and the washed copolymer was collected by filtration. The washing and filtration were repeated three times. Thereby, the copolymer having a weight average molecular weight Mw of about 9,400 and a molecular weight distribution of 1.52 was obtained at a yield of 47%.

What is claimed is:

1. A method for producing a resin for a chemically amplified positive resist comprising the step of polymerizing at least one monomer and/or at least one oligomer which is polymerized to provide a resin for a chemically amplified positive resist, wherein at least two polymerization initiators are used to initiate the polymerization.

2. The method according to claim 1, wherein each of the polymerization initiators is a compound of the formula (1) or (2): 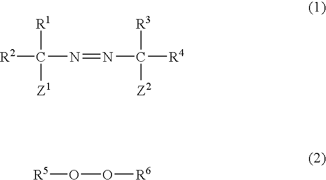
wherein Z¹ and Z² each independently represent an electron-withdrawing group, and R¹, R², R³, R⁴, R⁵, and R⁶ each independently represents an alkyl group having 1 to 10 carbon atoms or an alkyl group containing a cyclic structure and having 3 to 10 carbon atoms, provided that R¹ and R², or R³ and R⁴ may be bonded to form a divalent saturated hydrocarbon group, and that at least one hydrogen atom in the substituents R¹, R², R³, R⁴, R⁵ and R⁶ may optionally be substituted with an aromatic group, a hydroxyl group, a halogen atom or an amino group, or at least one —CH₂— group may optionally be substituted with a carbonyl group or a carboxyl group.

3. The method according to claim 1, wherein said monomer or oligomer comprises at least one ester, in which a residue of a tertiary alcohol is substituted on a carboxylic acid having an ethylenic double bond and which has a group that is cleaved by the action of an acid.

4. The method-according to claim 3, wherein said ester is at least one compound selected from the group consisting of 2-alkyl-2-adamantyl (meth.)acrylates, 1-(1-adamantyl)-1-alkylalkyl (meth)acrylates and 1-(2-alkyl-2-adamantyloxycarbonyl)alkyl (meth)acrylates.

5. The method according to claim 2, wherein at least one of the polymerization initiators is a compound of the formula (1) recited in claim 2.

6. The method according to claim 2, wherein all of the polymerization initiators are compounds of the formula (1) recited in claim 2.

7. A resin for a chemically amplified positive resist produced by a method comprising the step of polymerizing at least one monomer and/or at least one oligomer which is polymerized to provide a resin for a chemically amplified positive resist, wherein at least two polymerization initiators are used to initiate the polymerization.

8. A chemically amplified positive resist resin composition comprising a resin for a chemically amplified positive resist produced by a method comprising the step of polymerizing at least one monomer and/or at least one oligomer which is polymerized to provide a resin for a chemically amplified positive resist, wherein at least two polymerization initiators are used to initiate the polymerization, an acid generator, and a basic compound.
